(19) United States
(12) Patent Application Publication
(10) Pub. No.: US 2012/0124549 A1
(43) Pub. Date: May 17, 2012

(54) SYSTEM AND METHOD FOR CAPTURING PROJECT DESIGN DECISIONS

(75) Inventor: PHILLIP JAMES ROBINSON, Histon, Cambridge (GB)

(73) Assignee: GENERAL ELECTRIC COMPANY, Schenectady, NY (US)

(21) Appl. No.: 12/945,368

(22) Filed: Nov. 12, 2010

(51) Int. Cl. G06F 9/44; G06F 17/21

(52) U.S. Cl. 717/102; 715/256; 715/229

(57) ABSTRACT

A computer-based method for capturing project design decisions includes: providing a main page and at least one secondary page; receiving information from users and placing it on the secondary page; forming a secondary page summary text portion on one of the secondary pages in response to a tag command received from an authorized user; and linking the secondary page summary text portion to a summary text portion on the main page.

### BACKGROUND OF THE INVENTION

The subject matter disclosed herein relates to product design and, in particular, to capturing decisions made during project design.

Many projects require multiple working groups working in multiple stages to achieve a desired result. Typically, at least some planning is performed before the project is begun to define and coordinate the different stages and assign responsibility for them to certain individuals.

One paradigm for project development is the so-called “waterfall model.” The waterfall model is a rigidly structured, sequential project development process that flows from one phase to another. In the waterfall process, the project does not move from a current phase to the next phase until the current phase is completed. In this manner, progress is seen as flowing steadily downwards (like a waterfall) through the phases of the development. The waterfall model was originally used for manufacturing projects and was an early model used in the development of software where it experienced varying degrees of success. In the waterfall model a single document typically defines and tracks design decisions that are made during the planning phase. Such a document typically cannot easily accommodate design decision changes.

Another development process that may be employed in project development is the “agile” development model. In the case of a software project, such a model is commonly referred to as “agile software development.” Agile software development may generally be defined as including iterative and incremental software development stages, where the requirements and solutions for each stage evolve through collaboration between self-organizing, cross-functional teams.

In the agile development process architecture and design of software is evolutionary. Consequently there is less emphasis of the production of large, very detailed architecture/design documents up-front as in traditional waterfall development processes. Instead design happens just-in-time and utilizes more flexible technologies to capture the essence of the design.

A common technology is a wiki, which is a web-enabled service that allows users to input information into one location that is visible to other users. However, while using a wiki to capture design decisions is very flexible and corresponds well to the agile software design principles, it does not provide a structure for capturing key information that may be needed at later times. For example, some types of decisions, such as using .NET rather than Java for enterprise integration, frame the approach to implementing solutions technically. These types of decisions and the reasoning behind them need to be very clearly visible to developers for the lifetime of the product. But when they are captured in a wiki they may not have this visibility.

### BRIEF DESCRIPTION OF THE INVENTION

According to one aspect of the invention, a system for capturing project design decisions that includes a computing system and logic executing on the computing system is disclosed. The logic implements a method that includes: maintaining a main page and at least one secondary page; allowing users of the computing system to provide information to the at least one secondary page; forming a secondary page summary text portion on one of the secondary pages; and linking the secondary page summary text portion to a summary text portion on the main page, wherein authorization to cause the linking is limited to a subset of the users.

According to another aspect of the invention, a computer-based method for capturing project design decisions is disclosed. The method of this aspect includes: providing a main page and at least one secondary page; receiving information from users and placing it on the secondary page; forming a secondary page summary text portion on one of the secondary pages in response to a tag command received from an authorized user; and linking the secondary page summary text portion to a summary text portion on the main page.

According to another aspect of the invention, a computer program product for capturing project design decisions is disclosed. The computer program product of this aspect includes a computer-readable storage medium having instructions embodied thereon, which when executed by a computer cause the computer to implement a method that includes: providing a main page and at least one secondary page; receiving information from users and placing it on the secondary page; forming a secondary page summary text portion on one of the secondary pages in response to a tag command received from an authorized user; and linking the secondary page summary text portion to a summary text portion on the main page.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 illustrates several web pages that form a system according to one embodiment of the present invention;

FIG. 2 shows an example user screen illustrating an operation according to one embodiment; and

FIG. 3 shows an example of a computing system on which embodiments of the present invention may be implemented.

The detailed description explains embodiments of the invention, together with advantages and features, by way of example with reference to the drawings.

### DETAILED DESCRIPTION OF THE INVENTION

As described above, when design decisions are captured in a wiki, the reasons for these decisions and, indeed, the decisions themselves may be lost or difficult to find. Accordingly, in one embodiment, a technical effect of the invention disclosed herein includes providing a structure for recording design decisions in a wiki page and a toolset for easily “tagging” and “promoting” the information related to the design decisions to a main page that is not subject to change or modification most of the users of the wild page.

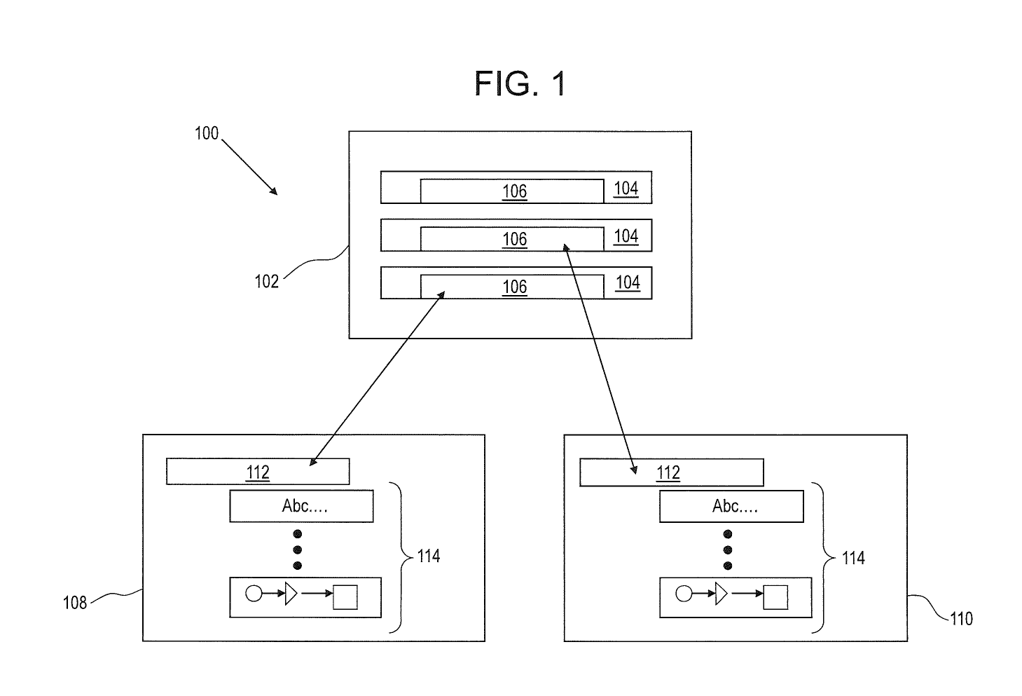

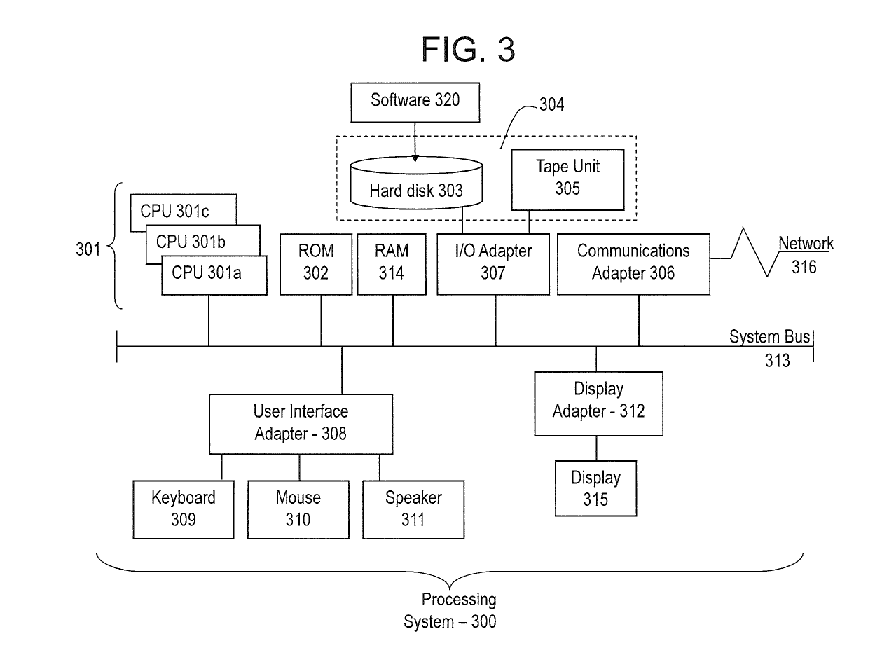

FIG. 1 illustrates several web pages that form a system 100 according to one embodiment of the present invention. It shall be understood that the system 100 may be so-called “wiki system,” or simply a “wiki” herein. The system 100 can be powered by any type of wild software currently known or later developed and allows, at least in a limited sense, any user who has access to the system 100 to post information to the system. The system 100 can be implemented on one or more computing devices such as the computing system shown, for example, in FIG. 3. Of course, the computing system of FIG. 3 can also be referred to as a server in some embodiments.

In one embodiment, the system 100 includes a main page 102. The main page 102 can include, for example, one or more different summary sections 104 in one embodiment. In one embodiment, the summary sections 104 include a design principle, a design decision or a system quality. Of course, the summary sections 104 could include other information. In one embodiment, the information in the summary sections 104 is information that is usually contained in architecture specification documents. However, in one embodiment and in contrast to a typical design specification document, on the main page 102 the summary sections 104 do not include accompanying detail about the decision or how those decisions were reached. As such, in one embodiment the main page 102 can serve as the initial point of contact for those users who wish to understand what design principles, decisions, etc. are for a particular product. In one embodiment only one or a limited number of users are allowed to change or otherwise manipulate the main page 102.

In one embodiment, one or more of the summary sections 104 include a summary text portion 106. The summary text portion 106 can include, in one embodiment, a brief summary of the particular design principle or other information in the summary section 104. One or more of the summary text portions 106 can be linked by hyperlinks 107 to one or more different, secondary pages 108, 110. The ability to add the hyperlinks 107 from the main page 102 to another page can be limited to one or a limited number user in one embodiment.

In one embodiment, any user of the system 100 can post information to the secondary pages 108, 110. Of course, access can be limited to specific users in one embodiment. The number of secondary pages 108, 110 is not limited and can vary from one to any value. In one embodiment, each secondary page 108, 110 is devoted to a different topic. For example, secondary page 108 can be devoted to design principles and secondary page 110 can be devoted to system qualities.

In one embodiment, the secondary pages 108, 110 include one more secondary page summary text portions 112. In one embodiment, the summary text portion 106 and the secondary page summary text portions 112 are linked to one another and include the same text. Control of the linking of the summary text portion 106 and the secondary page summary text portions 112 is described in greater detail below.

As illustrated, the summary text portions 106 are linked to secondary page summary text portions 112 on different secondary pages 108, 110. It shall be understood that that multiple summary text portions 106 on the main page 102 can be linked to multiple secondary page summary text portions 112 on only one of the secondary pages 108, 110.

In one embodiment, the secondary page summary text portions 112 divide the secondary pages 106, 108 into categories according to project and can be accessed and added to by any user of the system 100. The secondary pages 106 also include one or more explanation sections 114. The explanation sections 114 can include, for example, diagrams, text, or any other type of information that can record or explain design decisions. In one embodiment, the explanation sections 114 are related to the secondary page summary text portion 112 immediately preceding it.

As in any wiki system, the secondary pages 108, 110 by their very nature evolve over time, as the design of the project is refined. In one embodiment, at key points in time a version of the secondary pages 108, 110 can be considered “definitive.” At these key time, an authorized individual (e.g., software architects or technical leads) can “tag” that version of the secondary pages 108, 110 such that the a particular summary text portion 106 is linked by hyperlinks 107 to the particular version of the secondary pages. In this scenario, an observer of the main page 102 would see the summary text portion 106, click on the link and go to that version of the secondary pages 108, 110 in the region where the linked secondary page summary text portion 112 is located.

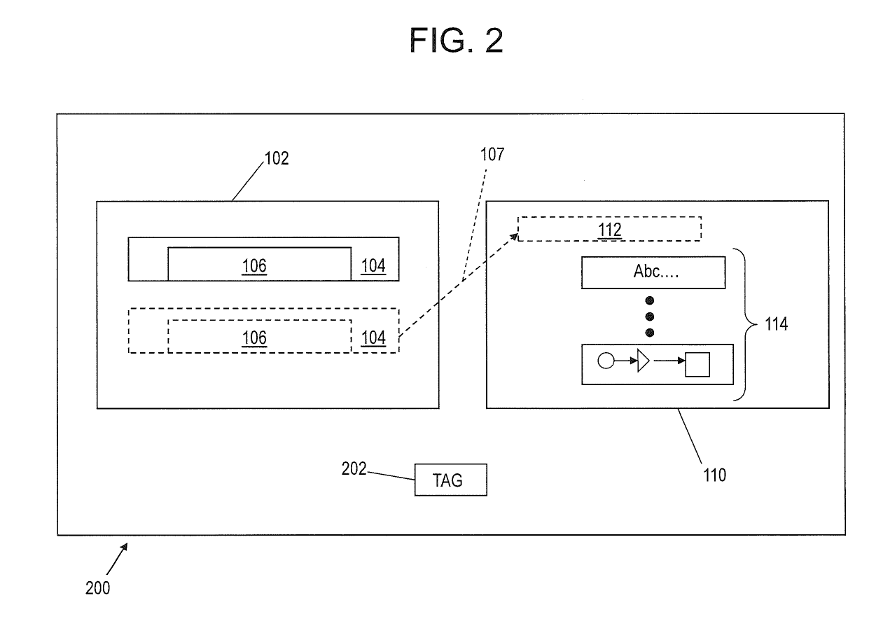

FIG. 2 shows an example user screen 200 illustrating an operation according to one embodiment. In this example, the user screen 200 includes the main page 102 and secondary page 110. As described above, the main page 200 includes one or more of the summary sections 104 that include summary text portions 106. As illustrated, the secondary page 110 includes explanation sections 114. In one embodiment, the user screen 200 also includes a tag selector 202. It shall be understood that the tag selector 200 could be a button icon on the screen 200, a button on a keyboard or be selectable in other manners.

In operation, a user can select one or more explanation sections 114. In one embodiment, the user then activates the tag selector 200 causing a dialog that categorizes the type of information that is being referred to. For example, in this example, the user has selected the illustrated explanation sections 114. The user then “tags” the section by activating the tag selector 202. This causes a new summary section 104 (shown in dashes) to be created and it is linked to the secondary page summary text portion 112 shown (also shown in dashes).

In an alternative embodiment, the secondary page summary text portion 112 may already exist. In such an embodiment, the user selects the secondary page summary text portion 112 and the new summary section 104 is linked to it. In this embodiment, the contents of the secondary page summary text portion 112 may be replicated in the summary text portion 106.

In one embodiment, after the tag selector 202 is activated, the user selects from a configurable selection of types for the summary section. Choices can include, for example, Design Principle, Design Decision, System Quality, or the like. In one embodiment one or more of these choices may raise a sub-types selection screen. For example, selection of System Quality may raise a sub-type selection screen where a user can select one or more of Performance, Scalability, Modularity, or the like. In one embodiment, the selected types are included in and describe the summary section 104 to which they relate.

According to one embodiment the end result is that the secondary page summary text portion 112 and the hyperlink 107 thereto allows for the information on the on the secondary page 110 to be captured, in a summary form, on the main page 102. Thus, those who are interested can use the main page 102 to see the current state of development with respect to the design as well as going back to previous and in-progress versions of the design if necessary. As a technical effect, embodiments of the present invention reduce the need to continually maintain and update large, unwieldy documents that have traditionally been used in waterfall development. Furthermore, embodiments of the present invention have the technical effect of allowing a design team to use more free-form technology (in this case, a wiki) to describe and evolve the design of a project while still maintaining an identifiable current design and relevant design decisions.

FIG. 3 shows an example of a computing system on which embodiments of the present invention may be implemented. As discussed above, the computing system of FIG. 3 can be server that users access from other computing systems. In this embodiment, the system 100 has one or more central processing units (processors) 301a, 301b, 301c, etc. (collectively or generically referred to as processor(s) 101). In one embodiment, each processor 301 may include a reduced instruction set computer (RISC) microprocessor. Processors 301 are coupled to system memory 314 and various other components via a system bus 313. Read only memory (ROM) 302 is coupled to the system bus 313 and may include a basic input/output system (BIOS), which controls certain basic functions of system 300.

FIG. 3 further depicts an input/output (I/O) adapter 307 and a network adapter 306 coupled to the system bus 313. I/O adapter 307 may be a small computer system interface (SCSI) adapter that communicates with a hard disk 303 and/or tape storage drive 305 or any other similar component. I/O adapter 307, hard disk 303, and tape storage device 305 are collectively referred to herein as mass storage 304. A network adapter 306 interconnects bus 313 with an outside network 316 enabling data processing system 300 to communicate with other such systems. A screen (e.g., a display monitor) 315 is connected to system bus 313 by display adaptor 312, which may include a graphics adapter to improve the performance of graphics intensive applications and a video controller. In one embodiment, adapters 307, 306, and 312 may be connected to one or more I/O busses that are connected to system bus 313 via an intermediate bus bridge (not shown). Suitable I/O buses for connecting peripheral devices such as hard disk controllers, network adapters, and graphics adapters typically include common protocols, such as the Peripheral Components Interface (PCI). Additional input/output devices are shown as connected to system bus 313 via user interface adapter 308 and display adapter 312. A keyboard 309, mouse 310, and speaker 311 all interconnected to bus 313 via user interface adapter 308, which may include, for example, an I/O chip integrating multiple device adapters into a single integrated circuit.

Thus, as configured in FIG. 3, the system 300 includes processing means in the form of processors 301, storage means including system memory 314 and mass storage 304, input means such as keyboard 309 and mouse 310, and output means including speaker 311 and display 315. In one embodiment, a portion of system memory 314 and mass storage 304 collectively store an operating to coordinate the functions of the various components shown in FIG. 1.

It will be appreciated that the system 300 can be any suitable computer or computing platform, and may include a terminal, wireless device, information appliance, device, workstation, mini-computer, mainframe computer, personal digital assistant (PDA) or other computing device. It shall be understood that the system 300 may include multiple computing devices linked together by a communication network. For example, there may exist a client-server relationship between two systems and processing may be split between the two.

The system 100 also includes a network interface 106 for communicating over a network 116. The network 116 can be a local-area network (LAN), a metro-area network (MAN), or wide-area network (WAN), such as the Internet or World Wide Web. Users of the system 300 can connect to the network through any suitable network interface 316 connection, such as standard telephone lines, digital subscriber line, LAN or WAN links (e.g., T1, T3), broadband connections (Frame Relay, ATM), and wireless connections (e.g., 802.11(a), 802.11(b), 802.11(g)).

As disclosed herein, the system 300 includes machine-readable instructions stored on machine readable media (for example, the hard disk 304) for capture and interactive display of information shown on the screen 315 of a user. As discussed herein, the instructions are referred to as “software” 320. The software 320 may be produced using software development tools as are known in the art. The software 120 may include various tools and features for providing user interaction capabilities as are known in the art.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A system for capturing project design decisions, comprising:
a computing system; and
logic executing on the computing system, the logic implementing a method comprising:
maintaining a main page and at least one secondary page;
allowing users of the computing system to provide information to the at least one secondary page;
forming a secondary page summary text portion on one of the secondary pages; and
linking the secondary page summary text portion to a summary text portion on the main page, wherein authorization to cause the linking is limited to a subset of the users.

2. The system of claim 1, wherein linking is responsive to the activatiuon of a tag selector by a user and includes:
assigning a category to the summary text portion.

3. The system of claim 2, wherein the category is one of: design principle, design decision and system quality.

4. The system of claim 3, wherein the category includes a sub-category, the subcategory being one of: performance, scalability, and modularity.

5. The system of claim 1, wherein the project is a software development design project.

6. The system of claim 1, further comprising:
versioning at least one of the secondary pages; and
wherein linking occurs between the main page and a particular version of the at least one secondary page.

7. The system of claim 1, wherein secondary page summary text portions are related to one or more explanation section.

8. The system of claim 1, wherein the at least one secondary page is a wild.

9. A computer-based method for capturing project design decisions, the method comprising:
providing a main page and at least one secondary page;
receiving information from users and placing it on the secondary page;
forming a secondary page summary text portion on one of the secondary pages in response to a tag command received from an authorized user; and
linking the secondary page summary text portion to a summary text portion on the main page.

10. The method of claim 9, wherein the summary text portion and the secondary page summary text portion include the same text.

11. The method of claim 9, wherein linking includes:
assigning a category to the summary text portion.

12. The method of claim 11, wherein the category is one of: design principle, design decision and system quality.

13. The method of claim 12, wherein the category includes a sub-category, the subcategory being one of: performance, scalability, and modularity.

14. The method of claim 9, wherein the project is a software development design project.

15. A computer program product for capturing project design decisions, the computer program product comprising a computer-readable storage medium having instructions embodied thereon, which when executed by a computer cause the computer to implement the method of claim 9.
